(19) United States
(12) Patent Application Publication
(10) Pub. No.: US 2006/0031827 A1
(43) Pub. Date: Feb. 9, 2006

(54) System, apparatus and method of assisting with software product update installations

(75) Inventors: Janel Guillory Barfield, Round Rock, TX (US); Susann Marie Keohane, Austin, TX (US)

Correspondence Address: IBM CORPORATION (VE);C/O VOLEL EMILE, P. O. BOX 202170, AUSTIN, TX, 78720-2170, US

(73) Assignee: International Business Machines Corporation, Armonk, NY (US)

(21) Appl. No.: 10/912,475

(22) Filed: Aug. 5, 2004

(51) Int. Cl. G06F 9/44

(52) U.S. Cl. 717/168

(57) ABSTRACT

A system, apparatus and method of assisting with software product update installations are provided. When a software product is to be updated, a plurality of deployment descriptors are recursively read to determine all dependencies of the software product. Once all the dependencies have been determined, a list of the dependencies is presented for installation as a solution update.

### BACKGROUND OF THE INVENTION

1. Technical Field

The present invention is directed to software maintenance. More specifically, the present invention is directed to a system, apparatus and method of assisting with software product update installations.

2. Description of Related Art

Most software products depend on other software products to perform their tasks. For example, IBM WebSphere Application Server (WAS), which is a Java-based server that is used to deploy and manage Web applications, may use a database system from which it can retrieve data and into which it can store data. Thus, WAS may depend on both Java and a database system. Further, since WAS, Java and the database system are generally installed on an operating system (OS), they all depend on the OS.

In some instances, there may be nested dependencies. For example, a feature of WAS may depend on a feature of Java which itself may depend on a feature of the OS. Because of these nested dependencies, maintaining a software product may at times be work-intensive and frustrating.

As an example, suppose a WAS update is posted on a Web site, as is currently customary, to be downloaded for installation. Suppose further that after the update is downloaded and while it is being installed it is discovered that the update depends on an updated version of Java. Then, the WAS update installation has to be suspended until the Java update is installed. If, while the Java update is being installed, it is discovered that it depends on an updated version of an OS library, the Java update has to itself be suspended until the OS library is updated. If after finally installing the Java update it is discovered that the WAS update also depends on a database system update that has not yet been installed, the WAS update may again have to be suspended until the database system update is installed. This process may repeat for each update version of a software product on which the WAS depends. Obviously, this can be a rather frustrating endeavor.

The level of frustration may however be mitigated if one is aware of these dependencies. This awareness may be obtained through either documentation or expert knowledge. For example, if the WAS update includes documentation that indicates that it depends on some updated version of a database system and/or Java, or if an installer knows of such dependency, the requisite updated version of the database system and/or Java may be installed before the WAS update installation is attempted. However, as will be explained fully later, it is unlikely that the documentation will contain information about nested dependencies in certain instances.

Thus, what is needed is a system, apparatus and method of generating a list of dependencies for assisting with software product update installations.

### SUMMARY OF THE INVENTION

The present invention provides a system, apparatus and method of assisting with software product update installations. When a software product is to be updated, a plurality of deployment descriptors are recursively read to determine all dependencies of the software product. Once all the dependencies have been determined, a list of the dependencies is presented for installation as a solution update.

In a particular embodiment, the dependencies are determined by querying a database to find the location of a deployment descriptor database. The deployment descriptor database may presumably contain a deployment descriptor of at least one dependency. This descriptor may be read to obtain a required version of the dependency. Further, the system on which the product is installed may also be queried to obtain the version of the dependency that is presently installed. If the two versions do not match, the name of the dependency and the required version may be entered into a log file to be presented to a user. Note that querying the database for a descriptor of a dependency, reading the descriptor for the required version, querying the system on which the product is installed for the presently installed version of the dependency and comparing the required version to the installed version may be repeated for each dependency in the list of dependencies.

In another embodiment, a service scout agent that may be running on the system on which the product is installed may be used for facilitating the update. In this case, the service scout agent may query a service website for availability of updates or may be notified of such. Upon being aware of an update, the service scout agent may track dependencies of the product to be updated by reading a plurality of deployment descriptors recursively. After doing so, the service scout agent may provide a list of the dependencies to the user.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram illustrating a distributed data processing system according to the present invention.

FIG. 2 is an exemplary block diagram of a server apparatus according to the present invention.

FIG. 3 is an exemplary block diagram of a client apparatus according to the present invention.

FIG. 4a depicts an exemplary deployment descriptor.

FIG. 4b depicts an exemplary log file that may be used by the invention.

FIG. 5 is a flowchart of a process that may be used by the invention.

### DETAILED DESCRIPTION OF THE PREFERRED EMBODIMENT

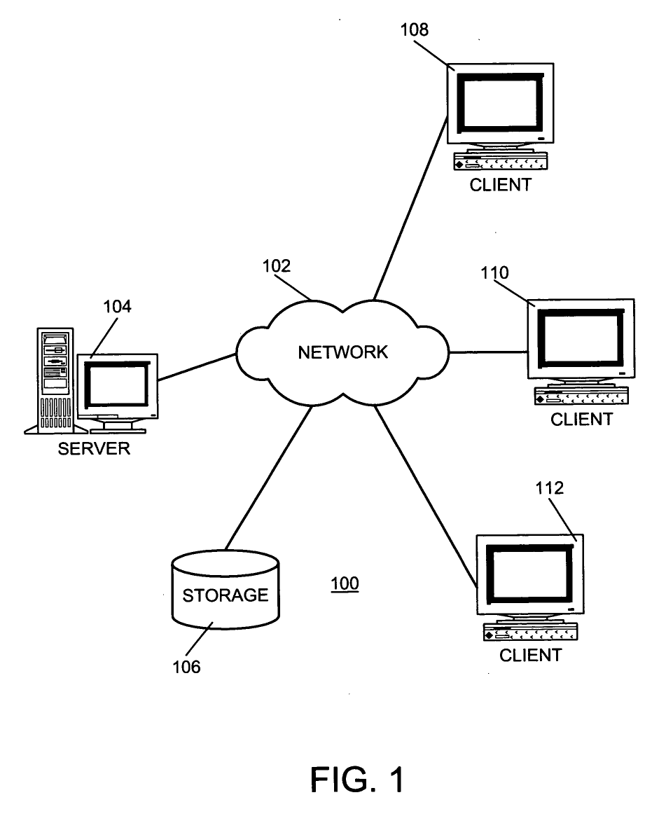

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108, 110 and 112. Clients 108, 110 and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

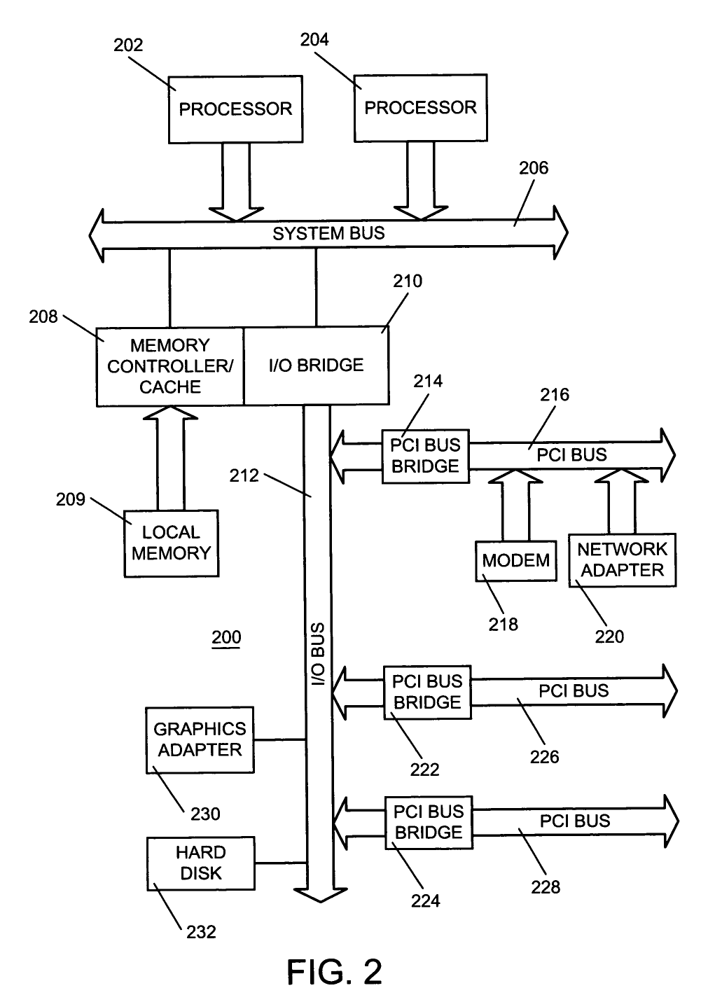

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to network computers 108, 110 and 112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

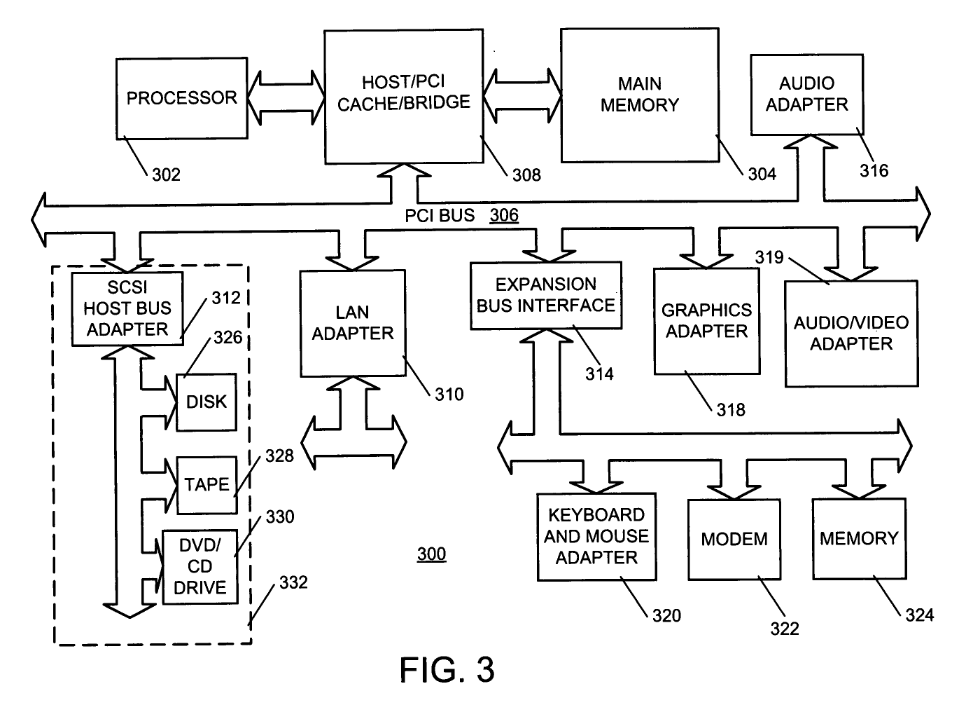

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM/DVD drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP™, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 may also be a notebook computer or hand held computer in addition to taking the form of a PDA. Data processing system 300 also may be a kiosk or a Web appliance.

The present invention provides a system, apparatus and method of generating a list of dependencies including nested dependencies of a software product for assisting with update installations. The invention may be local to client systems 108, 110 and 112 of FIG. 1 or to the server 104 or to both the server 104 and clients 108, 110 and 112. Further, the present invention may reside on any data storage medium (i.e., floppy disk, compact disk, hard disk, ROM, RAM, etc.) used by a computer system.

There presently is an emerging set of standards that requires that software products provide information about themselves and their dependencies. This information is generally provided in a deployment descriptor. A deployment descriptor is an extensible Markup Language (XML) document that provides assembly and deployment information. Assembly is all the files that comprise the software product, including resource, security management, versioning, sharing and deployment information files. Deployment information includes the location where the product may be found (i.e., disks, directories, Web sites etc.). Note that to deploy a software product is to install the product on a computer system. The information in the deployment descriptor is used during installation, update as well as un-installation of the product to check the product's dependencies and to populate and update registries on the system with information regarding the product.

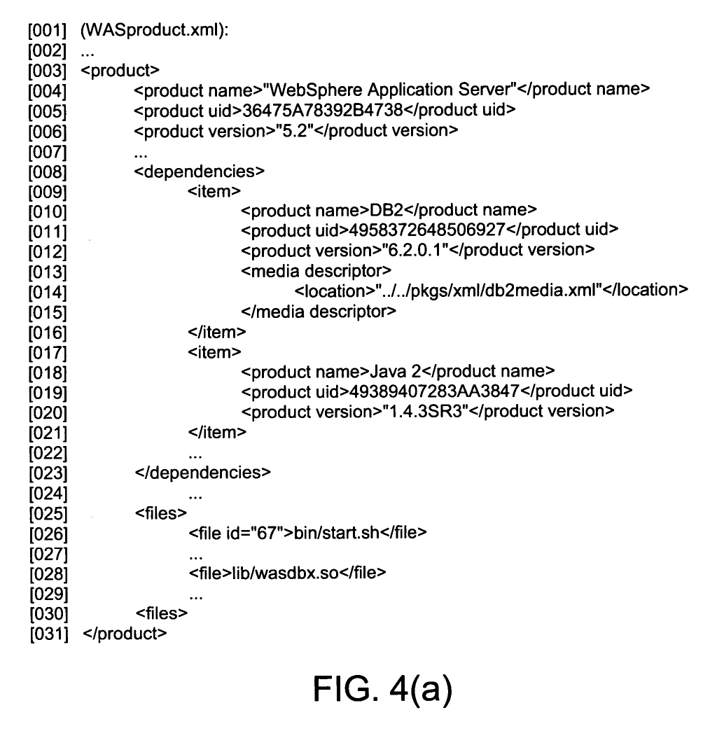

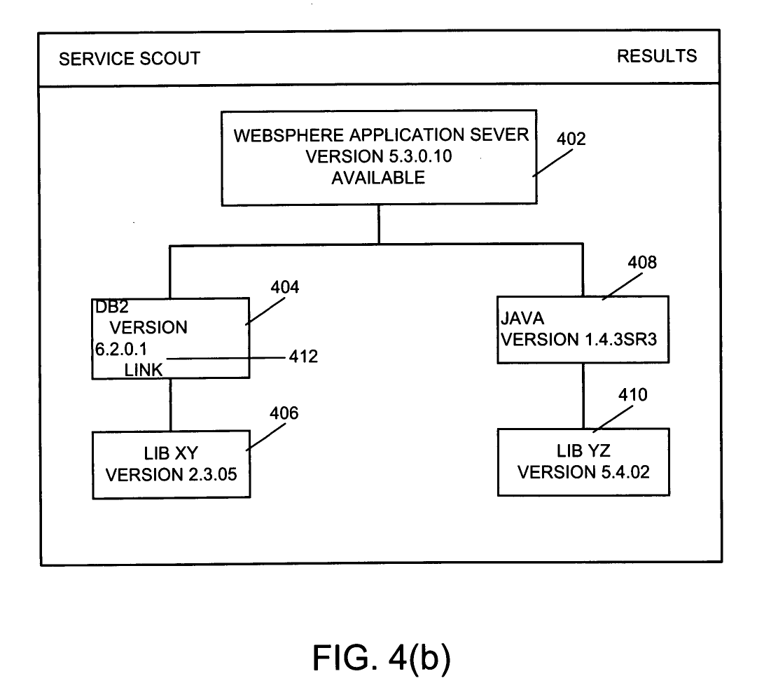

FIG. 4a depicts an exemplary deployment descriptor. On line [004] of the deployment descriptor, the product with which the descriptor is associated is identified as WebSphere Application Server. The version of the product is on line [006] and the unique identifier of the version of the product is on line [005]. The product has two dependency products. The first dependency product, which is DB2, is on line [009] to line [016] and the second dependency product, which is Java, is on line [017] to line [021].

The deployment descriptor is usually packaged with the product itself. To continue with the example used above, WAS, the database system (i.e., DB2) and Java are each a product. Therefore each one may contain a deployment descriptor packaged therewith. Multiple products may be packaged together as a solution. In this case, WAS, the database system, Java and all requisite system files may be packaged together as a solution. A solution package also contains a deployment descriptor that describes the entire solution. Thus, in the case of a solution package, all inter-dependencies and nested dependencies will be available in the deployment descriptor of the solution.

However, when a product is packaged individually, the deployment descriptor may not provide information regarding nested dependencies. The present invention uses a service scout to provide such information.

The service scout is an agent that may run on a customer's computer system and is used to query a service Web site for updates availability. Alternatively, the service scout may be notified by the service site when an update is available. Once, the service scout becomes aware that an update is available, the service scout may access the deployment description of the update of the product to determine whether it has any dependencies on other products (or 1^{st} level dependency products). For example, if the deployment descriptor in FIG. 4a is an update to WAS, after accessing the descriptor, the scout agent may determine that WAS has two dependency products: DB2 identified on line [009] to line [016] and Java identified on line [017] to line [021]. Note that dependencies are marked with a standard XML tag in the deployment descriptor (see lines [008] and [023] of FIG. 4a).

If the update indicates that the product depends on a 1^{st} level dependency product, the scout may then compare the version of the 1^{st} level dependency product that is presently installed on the system with the requisite version indicated in the deployment descriptor of the update. To obtain the version of a product that is installed on a system, the scout may query a software inventory tool or package manager, which may be part of the OS. For example, to get to the software inventory tool in AIX (a product of IBM Corp.) the scout may use the command “lslpp” whereas in Linux the scout may use the command “rpm-qa”. When “lslpp” is used, for example, a list of all software packages and their versions that are installed on the system will be returned. The scout may use the result of the command to compare the version of a dependency product that is presently installed on the system with the requisite version indicated in the deployment descriptor.

Thus, the scout may compare the DB2 product version found on line [012] to the version of DB2 installed on the system. If there is a not match, the scout agent may enter in a log file the name of the 1^{st} level dependency product and its required version. If there is a match, then the scout agent need not make an entry in the log file.

As mentioned above, the deployment information of the update may contain the location where the 1^{st} level dependency product may be obtained (i.e., a media, a Web site etc.). Therefore, the scout agent may go to that location and access the deployment descriptor of the 1^{st} level dependency product to determine its dependencies. If the 1^{st} level dependency product depends on a 2^{nd} level dependency product, the scout may compare the version of the 2^{nd} level dependency product presently installed on the system with the requisite version of the 2^{nd} level dependency product as indicated in the deployment descriptor of the 1^{st} level dependency product. As before, if there is a match the scout agent need not make an entry in the log file. However, if there is not a match, the scout agent may enter the name of the 2^{nd} level dependency product and its requisite version in the log file. This process may repeat until a product is encountered that does not depend on another product. Further, this process may repeat for each 1^{st} level dependency product, just like it may repeat for every 2^{nd} level dependency product etc. until all dependency products are evaluated.

If the deployment information of any one of the products does not contain the location where a lower level dependency product may be obtained, the scout agent may query a database that may contain the needed information. This database may be a database that may contain all the products from a particular company or all the products that make up a product solution. For example, IBM may store the products that make up the WAS solution in a database at a particular Web location.

To query the database, the scout agent may use the product unique identifier. As an example, if the deployment descriptor of the update (i.e., FIG. 4a) did not contain the location where the DB2 product could be found, the scout agent might then query the database for the unique identifier of the DB2 product (see line [011] for the unique identifier of the DB2 product). The result of the query may be the location where the product is located.

Alternatively, if the deployment information of any one of the products does not contain the location where a lower level dependency product may be obtained, the scout agent may use grid computing technology. Grid computing is the use of geographically dispersed computers as one single unified computing resource. In grid computing, resources such as supercomputers, storage systems, data sources etc. which are owned by different organizations are pooled together to solve large-scale computational and data intensive problems in science, engineering and commerce.

To allow for an effective use of grid computing, a grid broker is used. The grid broker performs resource discovery and scheduling of tasks on the distributed grid resources. Thus, if the grid broker receives a request from a computer in New York to process an application program, the grid broker may, based on a resource discovery result, schedule the application program to be processed by a computer in Paris, France.

Consequently the scout agent may, using a grid computing technology, request the location of a deployment descriptor of a product. Upon receiving the request, the grid broker may perform a resource discovery for the deployment descriptor of the product using the product unique identifier. The result of the resource discovery may be the location (i.e., the computer system) where the product is located. The grid broker may then pass the information to the scout agent.

Thus, because descriptions of products and their dependencies are contained in standardized XML descriptors, they can be queries by a scout agent that checks for available updates at a service site. When the scout agent finds that a critical update of a product is available, it may follow the following steps:
(1) check the deployment descriptor of the update to find any dependencies for the update;
(2) after finding the dependencies, the scout agent may check the user's system to see if the dependencies are installed at the required level (for example, on AIX, the scout agent may use output of the “lslpp” command to get this information);
(3) if not, the scout agent may query a known database to find the location of a deployment descriptor database that contains the descriptor for each dependency.
(4) Steps 1, 2 and 3 may be repeated as many times as there are instances of dependency.

In this way, the dependency list of products (that are not already installed on the system) could be recursively gathered for the customer. When the complete list is gathered, the customer can be notified of the required update for the entire solution. The information may be presented to the customer in the format shown in FIG. 4b. Note that FIG. 4b is only an example of a user interface that may be used to provide the information to a customer. In other words, any other user interface may instead be used, so long as it provides the proper information to the customer.

FIG. 4b depicts an exemplary log file that may be used by the invention. This exemplary log file is used to complement the example mentioned earlier. The content of the log file illustrates the dependencies and nested dependencies mentioned above. Particularly, the log file contains the product that is to be updated (WAS 402). Before WAS 402 may be updated, database system DB2 404 has to be updated. However, before the database system DB2 404 may be updated, library xy 406 has to be updated to the version indicated. Likewise, library yz 410 needs to be updated before Java 408 may be updated. After, both the database system DB2 404 and Java 408 are updated, WAS 402 may be updated. In certain instances, a link where the requisite software product may be found may be entered in the log file (see link 412) to facilitate installation. Note that WAS, DB2, Java are used for illustrations purposes only. Thus, the invention is not thus restricted.

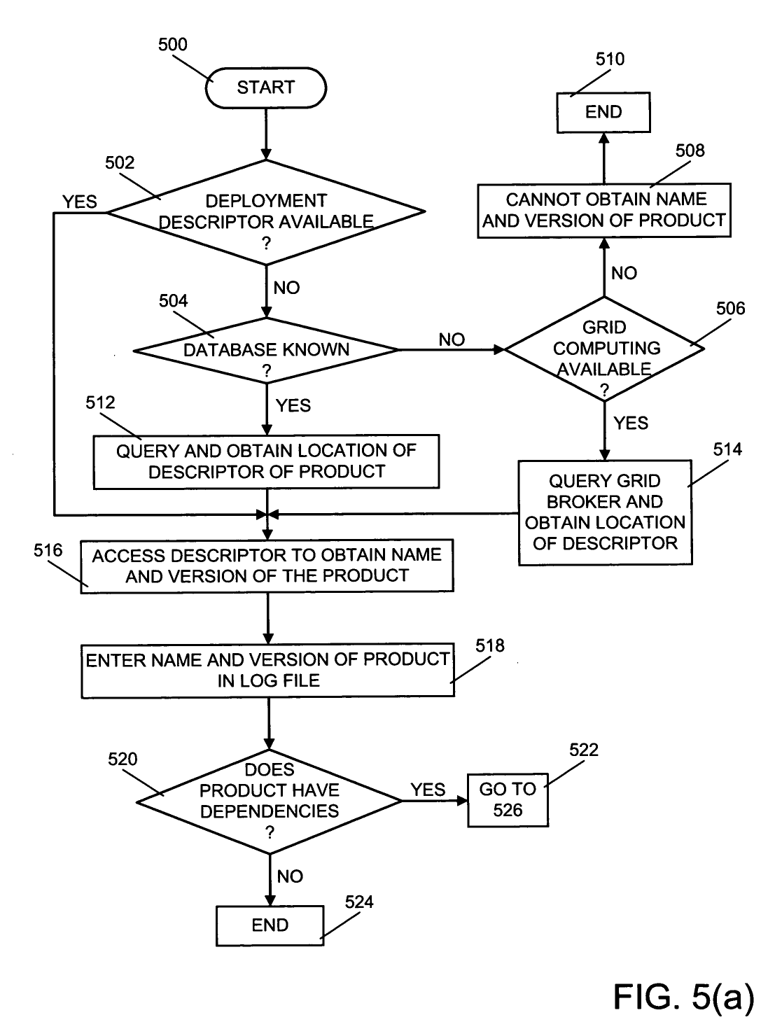

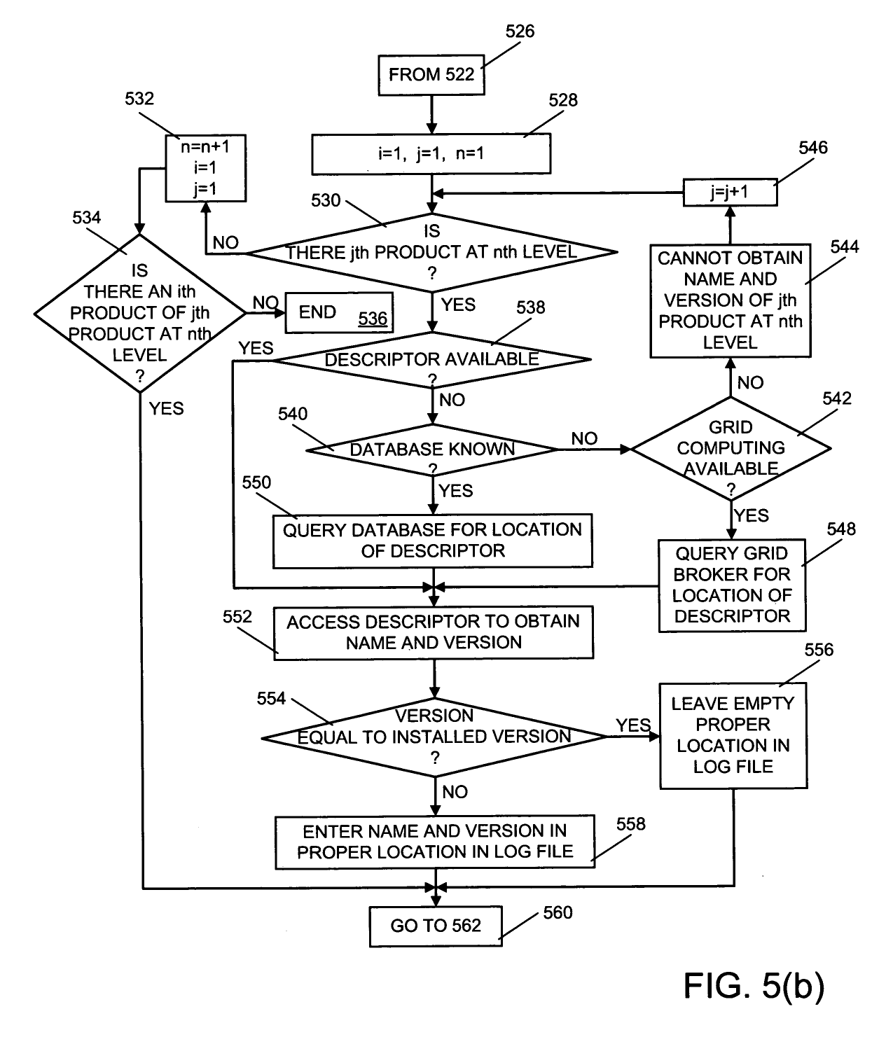

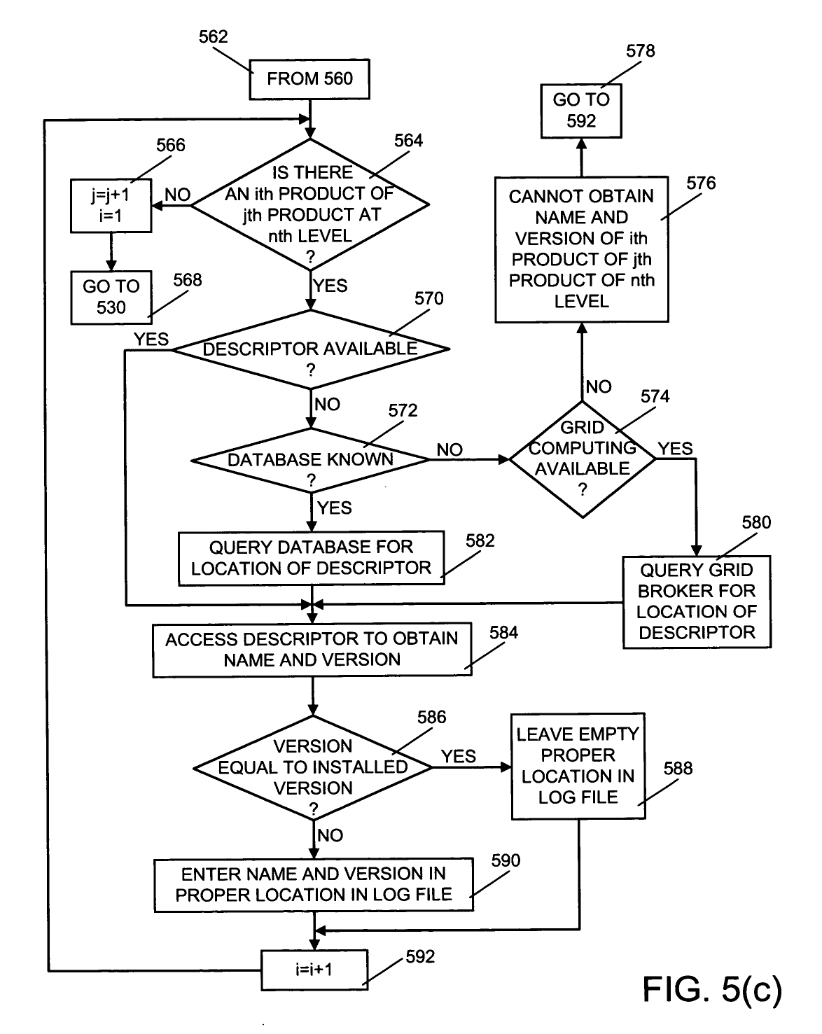

FIG. 5 is a flow chart of a process that may be used to implement the invention. The process starts when the service scout is aware that an update of a product is available (step 500). As mentioned above, the service scout may become aware of the availability of the update by querying a service Web site for updates availability or by being notified by a service site that an update is available. Once, the service scout becomes aware that an update is available, the service scout may check to see if the deployment descriptor of the product being updated is packaged with the update of the product (step 502). If so, the service scout may access the descriptor to obtain the name and the version of the product to be updated (step 516). If the deployment descriptor is not packaged with the update, the service scout may determine whether there is a known database it can query for the location of the deployment descriptor (step 504). If so, it may query the database for the location of the deployment descriptor (step 512). If not, the service scout may check to see whether a grid computing service is available (step 506). If so, it may query the grid broker for the location of the deployment descriptor (step 514). Once the location of the deployment descriptor is made available to the service scout, it may access the deployment descriptor to obtain the name and version of the product (step 516). If there is not a grid computing service available, the service scout may enter at the proper location in the log file an error message (i.e., name and version of product cannot be obtained) before the process ends (steps 508 and 510). After obtaining the name and version of the product, they are entered at the proper location in the log file (508). Then a check is made to determine whether the product has dependencies (520). If so, the process jumps to step 526 (step 522). If not, the process ends (step 524).

After jumping to step 526, the process goes to a plurality of loops to obtain the names and versions of all dependency products. If a version of a dependency product is not already installed on the system, the name and version of the product is entered at the proper location in the log file. If a version of a dependency product is already installed on the system, a blank space may be left at the proper location in the log file.

To implement the loops three variables, i, j and n are initialized to one (step 528). A check is then made to determine whether the j^{th} dependency product at the n^{th} level exists (step 530). If so, another check is made to determine whether the deployment descriptor of the product is readily available (step 538). If so, it is accessed to obtain the name and version of the product (step 552). If not and a database where the deployment descriptor is usually kept is known (step 540), the database may be queried for the location of the deployment descriptor (step 550). If not and a grid computing service is available (step 542), the grid broker may be queried for the location of the deployment descriptor (step 548). If there is not a grid computing service available, an error message (i.e., name and version of j^{th} product at the n^{th} level cannot be obtained) may be entered at the proper location in the log file before the variable j is increased by one so that the next j^{th} dependency product at the n^{th} level may be checked when the process returns to step 530 (steps 544 and 546).

When the location of the deployment descriptor of the j^{th} dependency product at the n^{th} level is known, it is accessed to obtain the name and version of the product (step 552). If the version of the product is the same as the one installed on the system, the proper location of the log file is left empty (steps 554 and 556). If the two versions are not the same, however, the version of the j^{th} product at the n^{th} level is entered at the proper location in the log file (steps 554 and 558). Then the process jumps to step 562. If there is not a j^{th} dependency product at the n^{th} level, the variable n is increased by one and both variable i and j are reset to 1. This will allow the deployment descriptor of the dependency products at the next level to be scrutinized (step 532). If there is not a dependency product at the next level then the process ends (steps 534 and 536). If so, then the process jump to step 562 (steps 534 and 560).

At step 562, a check is made to determine if there is an i^{th} dependency product of the j^{th} dependency product at the n^{th} level (step 564). If not, the variable j is increased by one and the variable i is reset to one and the process jumps back to step 530 where the deployment descriptor for the next j^{th} dependency product at the n^{th} level is accessed accordingly if it is available (steps 566 and 568). If there is an i^{th} dependency product of the j^{th} dependency product at the n^{th} level, its deployment descriptor will be accessed however found. That is whether its location is known (step 538), the database where it is located is known (steps 540 and 550) or its location is provided by a grid computing service (steps 542, 548). Its name and version will be entered at the proper location in the log file if the version is not already installed on the system (steps 584, 586 and 590). If the version has already been installed, the proper location in the log file will remain empty (steps 586 and 588). Then, the variable i is increased so that the deployment descriptor of the next dependency product of the j^{th} dependency product at the n^{th} level may be properly scrutinized (step 592). Note that if the location of the deployment descriptor of i^{th} dependency product of the j^{th} dependency product at the n^{th} level cannot be found, an error message may be entered at the proper location in the log file (step 576) and the process may jump to step 592 where the variable i is increased so that the deployment descriptor of the next dependency product of the j^{th} dependency product at the n^{th} level may be properly scrutinized (step 578).

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of assisting with software product updates comprising the steps of:
recursively reading a plurality of deployment descriptors to determine all dependencies of a software product; and
presenting a list of dependencies, as determined from recursively reading the plurality of the deployment descriptors, for installation as a solution update.

2. The method of claim 1 wherein the recursively reading step includes the step of:
querying a database to find location of a deployment descriptor database, the deployment descriptor database having a deployment descriptor of at least one dependency;
reading the deployment descriptor of the at least one dependency to obtain a required version of the dependency;
querying a system on which the product is installed to obtain the version of the dependency that is presently installed; and
entering into a log file name and version of the dependency if the version presently installed is not the same as the required version.

3. The method of claim 2 wherein the steps in claim 2 are repeated for each dependency of the software product.

4. A service scout agent running on a system for facilitating software updates comprising:
means for querying a service website for availability of updates or to be notified of such;
means, using deployment descriptors, for tracking dependencies of a software product to be updated by reading deployment descriptors recursively; and
means for providing to a user a list of the dependencies.

5. The service scout agent of claim 4 wherein the tracking means includes means for:
querying a database to find location of a deployment descriptor database, the deployment descriptor database having a deployment descriptor of at least one dependency;
reading the deployment descriptor of the at least one dependency to obtain a required version of the dependency;
querying a system on which the product is installed to obtain the version of the dependency that is presently installed; and
entering into a log file name and version of the dependency if the version presently installed is not the same as the required version.

6. A method of assisting with software product update installations comprising the steps of:
determining all products and their version on which an update of a software product depends by recursively accessing a plurality of documents, each document being associated with a product on which the update depends and indicating other products and versions of the other products on which the product associated therewith depends, the update being installed on a system;
comparing the versions of the products indicated in the accessed documents with versions of the products installed on the system; and
indicating all products that need to be updated before the update is installed, the products to be updated being the products whose versions do not match the installed versions.

7. The method of claim 6 wherein the documents are deployment descriptors.

8. The method of claim 6 wherein the step of indicating includes entering the products and versions in a log file.

9. The method of claim 6 wherein the products are placed in the log file in a manner illustrating which product depends on which version of which other product.

10. The method of claim 9 wherein a location where the version of the product may be found is placed in the log file.

11. A computer program product on a computer readable medium for assisting with software product updates comprising:
code means for recursively reading a plurality of deployment descriptors to determine all dependencies of a software product; and
code means for presenting a list of dependencies, as determined from recursively reading the plurality of the deployment descriptors, for installation as a solution update.

12. The computer program product of claim 11 wherein the recursively reading code means includes code means for:
querying a database to find location of a deployment descriptor database, the deployment descriptor database having a deployment descriptor of at least one dependency;
reading the deployment descriptor of the at least one dependency to obtain a required version of the dependency;
querying a system on which the product is installed to obtain the version of the dependency that is presently installed; and
entering into a log file name and version of the dependency if the version presently installed is not the same as the required version.

13. An apparatus for assisting with software product updates comprising:
means for recursively reading a plurality of deployment descriptors to determine all dependencies of a software product; and
means for presenting a list of dependencies, as determined from recursively reading the plurality of the deployment descriptors, for installation as a solution update.

14. The apparatus of claim 13 wherein the recursively reading means includes means for:
querying a database to find location of a deployment descriptor database, the deployment descriptor database having a deployment descriptor of at least one dependency;
reading the deployment descriptor of the at least one dependency to obtain a required version of the dependency;
querying a system on which the product is installed to obtain the version of the dependency that is presently installed; and
entering into a log file name and version of the dependency if the version presently installed is not the same as the required version.

15. A system having means for assisting with software product updates comprising:
at least one storage system for storing code data; and
at least one processor for processing the code data to recursively read a plurality of deployment descriptors to determine all dependencies of a software product, and to present a list of dependencies, as determined from recursively reading the plurality of the deployment descriptors, for installation as a solution update.

16. The system of claim 15 wherein the code data is further processed to query a database to find location of a deployment descriptor database, the deployment descriptor database having a deployment descriptor of at least one dependency, to read the deployment descriptor of the at least one dependency to obtain a required version of the dependency, to query the system to obtain the version of the dependency that is presently installed, and to enter into a log file name and version of the dependency if the version presently installed is not the same as the required version.

17. A computer program product on a computer readable medium for assisting with software product update installations comprising:
code means for determining all products and their version on which an update of a software product depends by recursively accessing a plurality of documents, each document being associated with a product on which the update depends and indicating other products and versions of the other products on which the product associated therewith depends, the update being installed on a system;
code means for comparing the versions of the products indicated in the accessed documents with versions of the products installed on the system; and
code means for indicating all products that need to be updated before the update is installed, the products to be updated being the products whose versions do not match the installed versions.

18. The computer program product of claim 17 wherein the documents are deployment descriptors.

19. A system being able to assist with software product update installations comprising:
at least one storage device for storing code data; and
at least one processor for processing the code data to determine all products and their version on which an update of a software product depends by recursively accessing a plurality of documents, each document being associated with a product on which the update depends and indicating other products and versions of the other products on which the product associated therewith depends, the update being installed on the system, to compare the versions of the products indicated in the accessed documents with versions of the products installed on the system, and to indicate all products that need to be updated before the update is installed, the products to be updated being the products whose versions do not match the installed versions.

20. The system of claim 19 wherein the documents are deployment descriptors.
